(19) United States
(12) Patent Application Publication
(10) Pub. No.: US 2008/0262061 A1
(43) Pub. Date: Oct. 23, 2008

(54) COMPOSITION AND USE OF A LIQUID FUNGICIDAL FORMULATION OF MYCLOBUTANIL OR TEBUCONAZOLE FUNGICIDE

(75) Inventors: Johnnie R. Roberts, Arlington, TN (US); Gregory C. Volgas, Bartlett, TN (US); Peter T. Delashmit, Memphis, TN (US)

Correspondence Address: Connolly Bove Lodge & Hutz LLP, 1007 North Orange Street, P. O. Box 2207, Wilmington, DE, 19899-2207, US

(73) Assignee: HELENA HOLDING COMPANY, Wilmington, DE (US)

(21) Appl. No.: 12/105,850

(22) Filed: Apr. 18, 2008

Related U.S. Application Data
(60) Provisional application No. 60/912,549, filed on Apr. 18, 2007.

(51) Int. Cl. A01N 43/707; A01P 3/00

(52) U.S. Cl. 514/383

(57) ABSTRACT

A fungicide composition containing a fungicide compound and a surfactant, wherein the fungicide is fully dissolved in the surfactant, and wherein the fungicide is selected from either myclobutanil or tebuconazole or a mixture thereof.

### RELATED APPLICATION

This application is based on and claims priority to U.S. Provisional Application No. 60/912,549, filed Apr. 18, 2007 which is incorporated by reference in its entirety for all useful purposes.

### BACKGROUND OF THE INVENTION

The invention pertains to a liquid fungicidal formulation of myclobutanil or tebuconazole fungicides or combinations of these two active ingredients and uses thereof.

Tebuconazole is chemically known as (RS)-1-p-chlorophenyl-4,4-dimethyl-3-(1H-1,2,4-triazol-1-ylmethyl)═pentan-3-ol.

Myclobutanil is chemically known as 2-p-chlorophenyl-2-(1H-1,2,4-triazol-1-ylmethyl)hexanenitrile.

Many agricultural formulations contain myclobutanil or tebuconazole. These fungicides are part of the azole class of fungicides and are noted for broad spectrum disease control. Myclobutanil and tebuconazole are not significantly water soluble. Since common fungicide applications are made using water as a carrier/diluent, concentrated preparations of these fungicides must be formulated using surfactants to disperse the active or solvents to dissolve the actives. When using solvents, the preparations normally employ surfactants to stably emulsify the solvent/active.

Some such commercial preparations of myclobutanil (Eagle 20 EW and Laredo EC) employ an aromatic solvent containing naphthalene to dissolve the myclobutanil. This aromatic solvent has a flash point over 200 degrees C. The solvent is volatile at normal application temperatures (0 to 40 degrees C.). This volatility is undesirable in many commercial applications because the inherent chemical odor of such applications is alarming to the general public. In EW formulations like this one, it is common for the active and solvent to be further diluted in water, so that the end concentrate contains the active ingredient dissolved in a solvent, and emulsified in water using surfactants.

The EW formulation is then commonly diluted further in water at the time of use. For a more complete description of EW formulations, reference Formulation Science, published in 1998 by the Association of Formulation Chemists, pages 276 and 277. This entire book is incorporated by reference. In these formulations, there is no appreciable or significant solubility of the active ingredient into the surfactant.

The EC formulation does not include a further addition of water to the concentrate. These formulations typically contain the active ingredient dissolved into a solvent, and surfactants are added. The purpose of the surfactants is to aid in the mixing of the solvent/Active ingredient with water at the time of use. For a more complete description of EC formulations, reference Formulation Science, published in 1998 by the Association of Formulation Chemists, pages 250 and 267.

Another such commercial preparation of myclobutanil (Laredo EW) contains similar aromatic solvents to the previously disclosed formulations, but further contains the solvent cyclohexanone. The MSDS sheet for each of the 3 described commercial formulations which describes these properties and are incorporated by reference in their entirety for all useful purposes.

U.S. Pat. Nos. 7,191,081; 6,103,768; 6,210,696; 6,653,256; 6,869,914; and 6,884,754 all disclose compositions which contain myclobutanil. These patents are incorporated by reference in their entirety for all useful purposes.

All of these commercial myclobutanil preparations share the common problems of volatility, relatively low flash points (203 degrees C.) and disagreeable odor.

These objections can be overcome by producing dispersions of the solid active ingredients in water. These formulations are generally referred to as Suspension Concentrates (SC) or Liquid Flowables. Such preparations include Folicur 3.6F. This formulation employs surfactants to disperse the tebuconazole active. Such formulations are inherently unstable and can separate in containers after prolonged storage. Furthermore, such formulations tend to reduce both phytotoxicity to desirable plants and fungicidal activity. While reduction of the plant injury is desirable, the associated loss of activity is a drawbacks Formulations employing dispersed solids are also subject to severe compatibility problems with other spray mixture components. Furthermore, these formulations can be expensive to produce and require a lot of energy in the form of milling operations to control particle size. For a more complete description of SC formulations, reference Formulation Science, published in 1998 by the Association of Formulation Chemists, pages 274 and 275.

Another method to overcome the objections of the aromatic solvent preparations is to produce dry powered or granular formulations (i.e. Eagle 40WP). When used in spray applications, these preparations form essentially the same type spray mixture as the liquid dispersions described previously. These solid formulations when dispersed in water or other spray carriers, ave the same drawbacks as those of the liquid dispersions.

U.S. Pat. No. 6,210,696 (Gore, et. al.) describes a dispersion of myclobutanil, among other fungicides in oil. These patent does not discuss or disclose ally appreciable solubility of the active fungicides.

U.S. Pat. No. 6,103,768 (Savage, et. al.) discloses a combination of a fungicidal fatty acid amine salt with myclobutanil or tebuconazole (and other fungicides). No discussion is provided nor mention made of the solubility of the other fungicidal actives.

U.S. Pat. No. 6,653,256 (Wolf, et. al.) discloses dispersions of fungicides including myclobutanil and tebuconazole in combination with amine derivatives of isocyanate mixtures. No mention is made of the dissolution of the fungicidal actives.

U.S. Pat. No. 6,869,914 (Bratz, etc.) discloses a process for the preparation of a solvent-free suspension of a low-melting point water-insoluble solid agrochemical active ingredient (including myclobutanil and tebuconazole), which comprises suspending 1-40% by weight of a silica-based carrier in 40 to 97% by weight of water in the presence of 1-40% by weight of anionic dispersant, heating the suspension thus obtained to a temperature above that of the active ingredient, and adding, with stirring, 1-25% by weight of a molten active ingredient with a melting point of <80.degree. C. or a mixture of at least two active ingredients each having a melting point of <80.degree. C. The present invention furthermore relates to the preparation of suspension concentrates, water-dispersible powders and water-dispersible granules based on the suspensions prepared via the abovementioned process. While the active fungicides described in this patent are melted at one point during the preparation, when the preparation is completed, and at room temperatures, and in the final formulation, the actives are in solid form and dispersed within a liquid phase.

U.S. Pat. No. 6,884,754 (Schlatter, et. al.) discloses an aqueous composition suitable for applying fungicides to plant propagation materials is provided, comprising water and a blend of the following components, by weight: a) 2-10% of a surface-active agent comprising al) at least one anionic surfactant; b) 0.5-10% of at least one polymer selected from water-dispersible polymers and water-soluble film-forming polymers; c) 4-20% of at least one inorganic solid carrier; and d) 3-20% of at least one antifreeze agent. In one embodiment, the composition comprises a fungicidally effective amount of at least one fungicidally active compound. The inventive composition is storage stable, ready-to-apply (RTA), ecologically and toxicologically favorable and has good fungicidal efficacy.

U.S. Pat. No. 7,199,081 (Schlatter, et. al.) discloses an aqueous composition suitable for applying fungicides to plant propagation materials is provided, comprising water and a blend of the following components, by weight: a) 2 10% of a surface-active agent comprising al) at least one anionic surfactant; b) 0.5 10% of at least one polymer selected from water-dispersible polymers and water-soluble film-forming polymers; c) 4 20% of at least one inorganic solid carrier; and d) 3 20% of at least one antifreeze agent. In one embodiment, the composition comprises a fungicidally effective amount of at least one fungicidally active compound. The inventive composition is storage stable, ready-to-apply (RTA), ecologically and toxicologically favorable and has good fungicidal efficacy.

It would be preferable then to have preparations of myclobutanil and tebuconazole that could be easily and completely dissolved in a solvent. The active ingredient should remain stably dissolved in the solvent at temperatures normally encountered in final application to plants, soil or seeds (0 to 45 degrees C.). The solvent should be relatively non-volatile, and should not have an objectionable odor. The flash point of the preparations should be higher than 200 degrees C. The preparations should also be readily dispersible in water for final application to growing plants, soil, or seeds.

### SUMMARY OF THE INVENTION

We have surprisingly discovered that myclobutanil and tebuconazole can be fully dissolved into surfactants. These surfactant solubilized fungicides are then seen to have improved spray mix compatibility and improved fungicidal effectiveness. These formulations also demonstrate reduced odor over aromatic solvent based formulations. Furthermore, the surfactants improve the wetting and coverage of applied sprays, which can enhance fungicidal activity.

One embodiment of the invention is a fungicide composition comprising at least one of either myclobutanil or tebuconazole and at least one surfactant in an effective amount such that said fungicide is dissolved in the surfactant and said at least one surfactant is present in a quantity equal to or greater than said at least one of myclobutanil or tebuconazole.

The invention also related to a process to produce a fungicidal composition which comprises blending a fully solubilized fungicide (being either myclobutanil or tebuconazole) with a surfactant to form a solution provided that said fungicide and surfactant are present in an amount of about 1 part by weight of fungicide to at least about 1.5 part by weight of surfactant.

The term fully soluble in this application means that the solid fungicide active ingredient (either myclobutanil or tebuconazole) is completely soluble in the surfactant at normal application temperatures (0 to 40 degrees C.), as judged by visual observations of no solid particles left after 8 hours or less agitation. During the 8 hours agitation, heat may be applied to expedite dissolution, but actual judgment of solubility is not made at elevated temperatures.

### DETAILED DESCRIPTION OF THE INVENTION

Tebuconazole is chemically known as (RS)-1-p-chlorophenyl-4,4-dimethyl-3-(1H-1,2,4-triazol-1-ylmethyl)=pentan-3-ol.

Myclobutanil is chemically known as 2-p-chlorophenyl-2-(1H-1,2,4-triazol-1-ylmethyl)hexanenitrile.

Useful surfactants or solvents include but are not limited to:

Alcohol alkoxylates including but not limited to:

Based on branched and linear alcohols

Those containing ethylene oxide or propylene oxide

Alcohol alkoxylate sulfates,

Alkylphenol alkoxylates including but not limited to:

Nonylphenol and octylphenols.

Those containing ethylene oxide or propylene oxide

Alkanolamides,

Alkylaryl sulfonates,

Amine oxides

Amines including but not limited to:

Fatty amine alkoxylates such as but not limited to tallowamine alkoxylates, Betaine derivatives,

Block polymers of ethylene and propylene glycol,

Carboxylated alcohol or alkylphenol alkoxylates,

Diols, including but not limited to Butanediols,

Diphenyl sulfonate derivatives,

Ethers, including but not limited to

Butyl celluslove,

Butyl carbitol,

Ethoxylated amines,

Ethoxylated fatty acids,

Ethoxylated fatty esters and oils,

Ethylene carbonate,

Fatty esters,

Glycerol esters,

Phosphate ester surfactants including but not limited to

Phosphate esters of alcohol alkoxylates,

Phosphate esters of alkylphenol alkoxylates,

Propylene Carbonate,

Sarcosine derivatives,

Silicone-based surfactants,

Sorbitan derivatives including but not limited to:

Sorbitan esters,

Alkoxylated sorbitan esters,

Sucrose and glucose derivatives including but not limited to:

Alkylpolyglucosides,

Sulfates and sulfonates of alkoxylated alkylphenols,

Sulfates of alcohols,

Tristyrylphenol Alkoxylates,

Other surfactants are disclosed in McCutcheon's Emulsifiers and Detergents, North American Edition, 2000.

Other surfactants are disclosed in the following patents:

U.S. Pat. No. 5,741,502 Homogeneous, essentially nonaqueous adjuvant compositions with buffering capability

U.S. Pat. No. 5,725,630 Dry granular fertilizer blend and a method of fertilizing plants

U.S. Pat. No. 5,580,567 Homogeneous, essentially nonaqueous adjuvant compositions with buffering capability

U.S. Pat. No. 5,393,791 Homogeneous, essentially nonaqueous adjuvant compositions with buffering capability

U.S. Pat. No. 5,234,919 Water soluble, highly active dimethoate formulations in an alcohol/ester solvent system

U.S. Pat. No. 5,178,795 Homogeneous, essentially nonaqueous adjuvant compositions with buffering capability

U.S. Pat. No. 5,906,961 Alkanolamide spreader-sticker surfactant combination

U.S. Pat. No. 5,877,112 Agricultural formulation

U.S. Pat. No. 6,232,272 Manufacture and use of herbicide chlorinated phenoxy formulation

The formulations may also contain oil-based components.

The oil or oil substitutes include, but are not limited to:

Alkylated fatty acid esters, include but are not limited to:

Methylated fatty acids, include but not limited to:

Methylated C6-C19 fatty acids,

Methylated Tall oil fatty acids,

Methylated Oleic acid,

Methylated Linoleic acid,

Methylated Linolenic acid,

Methylated Stearic acid,

Methylated Palmitic acid,

And blends thereof;

Ethylated fatty acids, include but are not limited to:

Ethylated C₆-C₁₉ fatty acids,

Ethylated Tall oil fatty acids,

Ethylated Oleic acid,

Ethylated Linoleic acid,

Ethylated Linolenic acid,

Ethylated Stearic acid,

Ethylated Palmitic acid,

And blends thereof,

Butylated fatty acids, include but are not limited to:

Butylated C₆-C₁₉ fatty acids,

Butylated Tall oil fatty acids,

Butylated Oleic acid,

Butylated Linoleic acid,

Butylated Linolenic acid,

Butylated Stearic acid,

Butylated Palmitic acid,

And blends thereof;

Alkylated natural oils, include but are not limited to:

Alkylated soybean oil, include but limited to:

Methylated soybean oil,

Ethylated soybean oil,

Butylated soybean oil,

And blends thereof;

Alkylated canola oil, include but are not limited to:

Methylated canola oil,

Ethylated canola oil,

Butylated canola oil,

And blends thereof;

Alkylated coconut oil, include but are not limited to:

Methylated coconut oil,

Ethylated coconut oil,

Butylated coconut oil,

And blends thereof;

Alkylated sunflower oil, include but are not limited to:

Methylated sunflower oil,

Ethylated sunflower oil,

Butylated sunflower oil,

And blend thereof;

Hydrocarbon oils include but are not limited to:

Mineral oils, including but are not limited to:

Paraffinic mineral oils,

Naphthenic mineral oils,

Aromatic mineral oils,

And blends thereof;

Vegetable oils, include but are not limited to:

Soybean oil,

Canola oil,

Cottonseed oil,

And blends thereof;

Fatty acids, include but are not limited to:

C₆-C₁₉ fatty acids,

Tall oil fatty acids,

Oleic acid,

Linoleic acid,

Linolenic acid,

Stearic acid,

Palmitic acid,

And blends thereof;

Polybutenes

Epoxified seed oils include but are not limited to:

Epoxified soybean oil and

Other oils or oil substitutes.

The formulation can contain at least one of the above oils or its equivalent. The oil can also be a blend of at least two oils. When an oil is used, a surfactant or emulsifier must also be used if the composition is intended for aqueous based sprays.

The composition preferably contains

(a) from about 1 to about 50% by weight of at least one of myclobutanil or tebuconazole, preferably about 5 to about 30% and most preferably about 10 to about 20% and

(b) at least about 8% of a surfactant and preferably at least 50% by weight of a surfactant, more preferably at least 70% by weight of a surfactant. Again the surfactant can be present in an amount from about 8 to about 99%, preferably about 50 to about 90%, and most preferably about 70 to about 80% and

(c) optionally other components.

The composition can further comprise another fungicide.

The fungicide composition can optionally contain an aromatic solvent. If the composition contains an aromatic solvent, the aromatic solvent is present preferably in an amount of at most 50% by weight and more preferably at most 40% by weight of an aromatic solvent and even more preferably at most 30% by weight of an aromatic solvent and even more preferably at most 20% by weight of an aromatic solvent and even more preferably at most 15% by weight of an aromatic solvent and even more preferably at most 10% by weight of an aromatic solvent and most preferably at most 5% by weight of an aromatic solvent.

The fungicide composition preferably contains a tebuconazole or myclobutanil and a surfactant in the ratio of fungicide to surfactant from about 1:6 to about 1:1.

The fungicide composition does not need to contain an alkylated fatty acid, alkylated plant derived oil and/or an alkylated animal derived oil.

Examples of these formulations are shown below. In all examples, the % listed for each component represent % by weight.

### EXAMPLE 1

| | |
|---|---|
| Myclobutanil technical | 15.0% |
| C₁₁ Alcohol (3EO) Ethoxylate | 85.0% |

### EXAMPLE 2

| | |
|---|---|
| Myclobutanil technical | 20.6% |
| Armak 2022 | 39.0% |
| Stepan 108 | 30.0% |
| Ethylan 1008 | 10.4% |

In this example, the Armak 2022 and Ethylan 1008 are alcohol ethoxylates and the Stepan 108 is a mixture of methylated fatty acids.

### EXAMPLE 3

| | |
|---|---|
| Myclobutanil technical | 30.0% |
| Armak 2022 | 70.0% |

In this example, the Armak 2022 is an alcohol ethoxylate.

### EXAMPLE 4

| | |
|---|---|
| Myclobutanil technical | 30.0% |
| Tomadol 91-6 | 25.0% |
| Genegen 4166 | 25.0% |
| Surfonic T-20 | 20.0% |

In this example, the Tomadol 91-6 is an alcohol ethoxylate, the Genegen 4166 is an N,N-dimethyl fatty acid amide and the Surfonic T-20 is a tallow amine ethoxylate,

### EXAMPLE 5

| | |
|---|---|
| Myclobutanil technical | 40.0% |
| Armak 2022 | 30.0% |
| Genegen 4166 | 30.0% |

In this example, the Armak 2022 is an alcohol ethoxylate and the Genegen 4166 is an N,N-dimethyl fatty acid amide.

### EXAMPLE 6

| | |
|---|---|
| Myclobutanil technical | 20.0% |
| Pluronic 62LF | 80.0% |

In this example, the Pluronic 62LF is a block copolymer of ethylene and propylene oxide.

### EXAMPLE 7

| | |
|---|---|
| Tebuconazole technical | 20.0% |
| Armak 2022 | 80.0% |

In this example, the Armak 2022 is an alcohol ethoxylate.

### EXAMPLE 8

| | |
|---|---|
| Tebuconazole technical | 20.0% |
| Armak 2022 | 70.0% |
| Methylated soybean oil | 10.0% |

In this example, the Armak 2022 is an alcohol ethoxylate.

### EXAMPLE 9

| | |
|---|---|
| Tebuconazole technical | 20.0% |
| Toximul 8362 | 80.0% |

In this example, the Toximul 8362 is an tallow amine ethoxylate.

### EXAMPLE 10

| | |
|---|---|
| Tebuconazole technical | 20.0% |
| AU-285 | 80.0% |

In this example, the AU-285 is a phosphate ester surfactant.

### EXAMPLE 11

| | |
|---|---|
| Tebuconazole technical | 10.0% |
| Myclobutanil technical | 10.0% |
| Armak 2022 | 80.0% |

In this example, the Armak 2022 is an alcohol ethoxylate.

In all of the above examples, the components are blended together and the fungicide technical dissolved entirely. In some cases, the mixtures had to be heated to expedite the dissolution of the technical. When the mixtures returned to room temperature, they were clear and free of precipitates. The solution formed contains less than 2% of precipitates and preferably 0% precipitates. Various additions can be made to the compositions as one may anticipate based on skill in the art. Other pesticides could be formulated using this composition. Fertilizers could be added to these compositions.

In all of the examples, the compositions can be mixed with water, or fertilizer, or oils for an end use application. Normally, the use rate of the formulations would be from 5 ounces to 128 ounces per acre and would be diluted in an agriculturally acceptable spray carrier used at between 128 ounces to 250 gallons per acre.

Also in all of these examples, the formulations can be applied directly to seed, as with many other fungicides.

When the compositions are mixed with water, they form either emulsions or stable micro-emulsions.

All references discussed herein are incorporated by reference in their entirety for all useful purposes including any of the references or EPA registration nos. described in the references.

1. A liquid fungicide composition comprising a fungicide compound and a surfactant, wherein said fungicide is fully dissolved in said surfactant, and wherein the fungicide is selected from either myclobutanil or tebuconazole or a mixture thereof.

2. The composition as claim 1 which further comprises an aromatic solvent.

3. The composition as claim 1 which further comprises methylated fatty acids.

4. The composition as claim 1 wherein the surfactant is an alcohol ethoxylate.

5. The composition as claim 1 wherein the surfactant is selected from the group consisting of
Alcohol alkoxylate,
Alcohol alkoxylate sulfate,
Alkylphenol alkoxylate,
Alkanolamide,
Alkylaryl sulfonate,
Amine oxide,
Amine,
Betaine derivative,
Block polymers of ethylene and propylene glycol,
Carboxylated alcohol or alkylphenol alkoxylate,
Diol,
Diphenyl sulfonate derivative,
Ether,
Phosphate ester surfactant,
Propylene Carbonate,
Sarcosine derivative,
Silicone-based surfactant,
Sorbitan derivative,
Sucrose and glucose derivative,
Sulfates or sulfonates of alkoxylated alkylphenol,
Sulfates of alcohol, and
Tristyrylphenol Alkoxylate and mixtures thereof.

6. The composition as claim 1 wherein the surfactant is selected from the group consisting of
Alcohol alkoxylates based on branched and linear alcohols or containing ethylene oxide or propylene oxide,
Alcohol alkoxylate sulfates,
Nonylphenol or octylphenols alkoxylate, optionally containing ethylene oxide or propylene oxide,
Alkanolamides,
Alkylaryl sulfonates,
Amine oxides,
Fatty amine alkoxylates such as but not limited to tallowamine alkoxylates, Betaine derivatives,
Block polymers of ethylene and propylene glycol,
Carboxylated alcohol or alkylphenol alkoxylates,
Diols, including but not limited to Butanediols,
Diphenyl sulfonate derivatives,
Butyl celluslove,
Butyl carbitol,
Ethoxylated amines,
Ethoxylated fatty acids,
Ethoxylated fatty esters and oils,
Ethylene carbonate,
Fatty esters,
Glycerol esters,
Phosphate ester surfactants including but not limited to
Phosphate esters of alcohol alkoxylates,
Phosphate esters of alkylphenol alkoxylates,
Propylene Carbonate,
Sarcosine derivatives,
Silicone-based surfactants,
Sorbitan derivatives including but not limited to:
Sorbitan esters,
Alkoxylated sorbitan esters,
Alkylpolyglucosides,
Sulfates and sulfonates of alkoxylated alkylphenols,
Sulfates of alcohols, and
Tristyrylphenol Alkoxylates and mixtures thereof.

7. The composition as claim 1 wherein the composition contains at least 40% fungicide.

8. The composition as claim 1 wherein the composition contains at least 30% fungicide.

9. The composition as claim 1 wherein the composition contains at least 20% fungicide.

10. The composition as claim 1 wherein the composition contains at least 10% fungicide.

11. The composition as claim 1 wherein the composition contains at least 50% surfactant.

12. The composition as claim 1 wherein the composition contains at least 60% surfactant.

13. The composition as claim 1 wherein the composition contains at least 70% surfactant.

14. The composition as claim 1 wherein the composition contains at least 80% surfactant.

15. The composition as claim 1 wherein the ratio of surfactant to fungicide is 1:1.

16. The composition as claim 1 wherein the ratio of surfactant to fungicide is 2:1.

17. The composition as claim 1 wherein the ratio of surfactant to fungicide is 3:1.

18. The composition as claim 1 wherein the ratio of surfactant to fungicide is 4:1.

19. The composition as claim 1 wherein the ratio of surfactant to fungicide is 5:1.
